(19) United States
(12) Patent Application Publication
(10) Pub. No.: US 2008/0192728 A1
(43) Pub. Date: Aug. 14, 2008

(54) Method for Accessing to a Service Through a Multichannel Access Network

(76) Inventors: Thierry Levesque, Chartres de Bretagne (FR); Jean-Francois Le Boite, Guichen (FR); Philippe Quenard, Acigne (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 10/590,178

(22) PCT Filed: Feb. 16, 2005
(86) PCT No.: PCT/FR2005/000354

§ 371 Date: Jun. 8, 2007

(30) Foreign Application Priority Data
Feb. 19, 2004 (FR) 04/50315

(51) Int. Cl. H04L 12/50

(52) U.S. Cl. 370/352

(57) ABSTRACT

The invention relates to a method for accessing to a service offered by a service provider on a communications network (2) from a terminal (T) through a multichannel access network (1), consisting in delivering by the service provider information at least concerning data about the address (@, P) of said service in the communications network (2) to a mediation module (4), in determining by the mediation module (4) at least one identifier (Sld, SClds) of a channel usable by the terminal (T) for accessing to the service and associating said channel identifier to information delivered by the service provider (S) and in receiving by the terminal (T) said channel identifier associated with information from the mediation module (4) when the service is detected. Said invention can be used for providing services through a multichannel access network or through a plurality of interfaces.

The present invention relates to a method used by a terminal to access through a multipath access network a service made available on a communication network by a service provider.

One particularly advantageous application of the invention lies in providing services, in particular over the Internet, when access to the service is effected via a multichannel access network or via a plurality of interfaces of the terminal. Access to the service is then said to be effected through a “multipath” access network.

Although the invention applies to any type of communication network, the remainder of this specification refers to the Internet. The service to which the terminal seeks access is referred to as the IP (Internet Protocol) service.

The general context of the invention is therefore that of a service provider seeking to transport an IP service such as video streaming or downloading, for example, to client terminals connected to a multichannel IP access network or to a plurality of IP access networks via a plurality of interfaces of the terminal. The term “path” is applied interchangeably to a channel of a multichannel access network and to an interface of a terminal.

An access network is referred to below as a multichannel access network if it contains either one physical medium providing a plurality of logical channels or a plurality of physical media. The term “channel” is then applied interchangeably to one of the logical channels on the one physical medium or to one of the plurality of physical media.

Multichannel access networks known in the art include DAB (Digital Audio Broadcasting) networks and DVB (Digital Video Broadcasting) networks.

Generally speaking, the client-terminal discovers the IP service using a “Service offer” function. At present, information transmitted by the provider is supplied beforehand to a mediation module and therefore to the terminal over the IP connection. That information includes the IP address(es) associated with a TCP/UDP (Transfer Control Protocol/User Datagram Protocol) port and the characteristics of the application to be used to process a given service, for example decoding characteristics and characteristics of the downloading application in the case of a video service.

It should be noted that to “consume” a given IP service a plurality of connections corresponding to a plurality of IP streams may be necessary, for example one connection for video and another for audio in the case of an audiovisual IP service. It is assumed below that the IP service contains only one IP stream. By analogy, the invention nevertheless covers the situation of a service associated with a plurality of IP streams.

In the case of access to an IP service through a multichannel network, the description of the service is usually provided by the service provider in an SDP (Service Description Protocol) type file as standardized by the IETF (Internet Engineering Task Force), but contains no information on the characteristics of the multichannel access network to be used, in particular the channel (logical channel/physical medium) to be used.

The network configuration mechanisms (routing tables, interface network configuration) of the terminal are conventionally used to find a communication route to a given IP service. However, these conventional techniques do not work in a situation where there is no network configuration associated with the logical channels beforehand, as is actually the case in DVB, DAB networks, for example.

Nevertheless, to avoid users having systematically to search all existing channels for an appropriate communication route to the IP service, the terminal must know the parameters for connecting to the access network in order to connect immediately to the correct channel (logical channel/physical medium).

For example, the IP service provider sends its content via an access network to an IP address @ associated with a port P. In parallel with this, at the time of IP service discovery, the IP service provider presents the terminal with a description of a multicast service, for example, by sending it the IP address @ and the port P and the nature of the application App to be used.

In the case of a DAB type multichannel access network, the access network equipments (IP encapsulation in DAB multiplex gateways) encapsulate the IP stream (@, P) in a multiplex set E, in a subchannel S of that multiplex, and in a packet Pa of that subchannel.

The terminal can connect to the IP service (@, P) only if its DAB access network configuration corresponds to the parameters (E, S, Pa) selected by the access network operator.

In the case of a DAB multichannel access network, the signaling sent by the equipments of the access network at present uses the identifier (service Id, service component Ids), referred to below as the (SId, SCIds) pair, uniquely characterizing a service component in a DAB network, since a given IP stream is transported in a single service component.

This identifier remains invariant regardless of the multiplexing/remultiplexing operations. The DAB access network signaling links the (SId, SCIds) pair to the physical media and to the logical channels used in the DAB transport system (set E, subchannel S, packet Pa). Accordingly, provided that it knows the (SId, SCIds) pair associated with a given IP service, the terminal can determine the connection channel (logical channel/physical medium) to the required IP service from the signaling received from the access network.

At present, the user must select the DAB network access parameters either manually and empirically or statically and contractually, for example by selecting the DAB service name and the name of the “service component”.

The terminal is then tuned to the correct physical medium and the correct logical channel and the IP data can therefore be extracted in accordance with the service description supplied by the IP service provider concerning the application level information and the IP connection.

In the case of a DVB multichannel network, a new table called the INT table defined in ETSI Specification EN 301 192 v1.3.1 (2003-05) is updated dynamically by the equipments of the DVB network (IP encapsulation in DVB gateways, multiplexer/remultiplexer) and provides a link between the encapsulated IP services (defined by the source and destination IP addresses, for example) and the channel (logical channel/physical medium) that transports them.

IP service discovery is effected independently by the terminal. Nevertheless, a portion of the IP service discovery information, in particular the characteristics of the IP connection such as the source and destination IP addresses, must be indicated in the DVB signaling in order to effect a connection to the access channel.

Nevertheless, the above prior art solutions for accessing an IP service via a multichannel access network all have a number of drawbacks.

With regard to the DAB network, at present the client must discover the IP services and configure the access network connection interface in two separate and independent operations.

Using the DAB access network to transport IP services is a recent development and in many cases is still somewhat experimental. A process whereby the client learns on which DAB channel defined by the (SId, SCIds) pair the IP streams are conveyed “statically” (for example contractually) may be suitable.

In a more dynamic environment, the client may not be aware in real time of assigning an IP service to an (SId, SCIds) pair. Moreover, the ergonomics of manual configuration can quickly deteriorate if changing from a given IP service to another necessitates virtually systematically reconfiguration of the access network connection interface.

In a DVB network, the DVB signaling table INT indicates the location of the given IP service dynamically but the terminal must perform a cross analysis of two types of signaling, i.e. the service discovery information and the information from the table INT. The identifier characterizing the IP service must be duplicated in the signaling of both types, thus leading to an information overload that significantly burdens DVB signaling and also increases the time spent on analysis by the terminal.

In the case of a terminal having a plurality of access network interfaces, a problem may arise when selecting the interface to which the client terminal must connect to receive a given multicast IP service if the service is accessible only via an access network that the terminal cannot predict a priori.

Thus the technical problem to be solved by the present invention is to propose a method used by a terminal to access a service via a multipath access network when that service is made available on a communication network by a service provider that, in situations where the terminal cannot know in advance how an IP service will be accessed, for example if it depends on the unpredictable implementation of the IP service in a multipath access network, would provide the terminal at the time of IP service discovery, and for example in an SDP file, information that would enable it to tune automatically to the correct channel (logical channel/physical medium) of the access network or to the correct interface to an access network, without the access operator creating any tables. This information must be up to date at the time of service discovery. If an identifier that is invariant in time and in space is used, the information transmitted at the time of the first service discovery will remain up to date throughout the duration of the service.

According to the present invention, the solution to the stated technical problem is for said access method to comprise the steps of:

the service provider supplying a mediation module with information relating at least to the address of said service in the communication network,

the mediation module determining at least one path identifier to be used by the terminal to access said service and associating said identifier with said information supplied by the service provider,

the terminal receiving said identifier associated with said information from the mediation module during service discovery.

As described in detail below, in the situation of multicast IP services on a DAB multichannel access network, for example, access from the terminal to the IP service may be summarized as follows:

In a first phase, the IP service provider wishing to offer a service through an access network operator supplies a mediation module with a description of the service that includes information elements found in a standard SDP file, namely:

application level information, such as a service name and literal description, the date of broadcasting the service, the application needed to decode the service, the type of codecs, etc.

network level information, such as the multicast IP address and the UDP port necessary for communicating with the multicast IP service.

If the above service description information is insufficient to make the resource request explicit enough, additional information is added, for example the identifier of the service with which the IP service is associated, such as the France Inter DAB service.

In a second phase, using the description of the service supplied by the IP service provider, the mediation module sends commands to the access network operator, which activates the IP transport resources that will be used to transport the IP service on a given channel. One example of the activation of IP transport resources is the control of IP data encapsulation gateways in the access network using the elements characterizing the IP service (IP address, port) and the IP service transport channel. In accordance with the invention, the access network control function sends back to the mediation module the channel that will transport the IP service. The mediation module then associates that channel information with other information received from the service provider.

In a third phase, the client uses a terminal to discover the service. The information that it receives, for example in an SDP file, contains at least:

the application level information (codecs, etc.),

the network level information (multicast IP address, port), and

(in accordance with the invention) the information linked to the access channel, for example the identifier SId of the DAB service and the identifier SCIds of the service component.

Finally, in a fourth phase, the terminal uses the above parameters to connect to the IP service. In the case of a multichannel network, the terminal tunes to the channel corresponding to said parameters. In the case of a plurality of interfaces, the terminal can dynamically configure its network parameters and even supply the applications with the access network interface to the service corresponding to said parameters.

The following description with reference to the appended drawings, which are provided by way of non-limiting example, explains in what the invention consists and how it can be reduced to practice.

FIG. 1 is a diagram of a communication system linking a server of a service provider and a terminal adapted to use the access method of the invention.

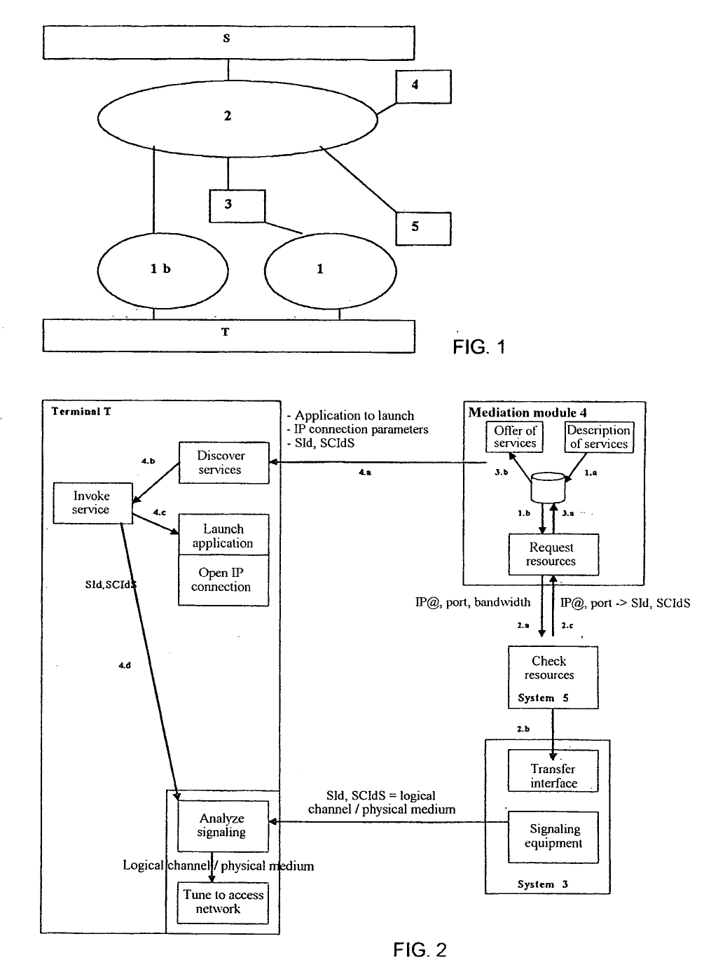

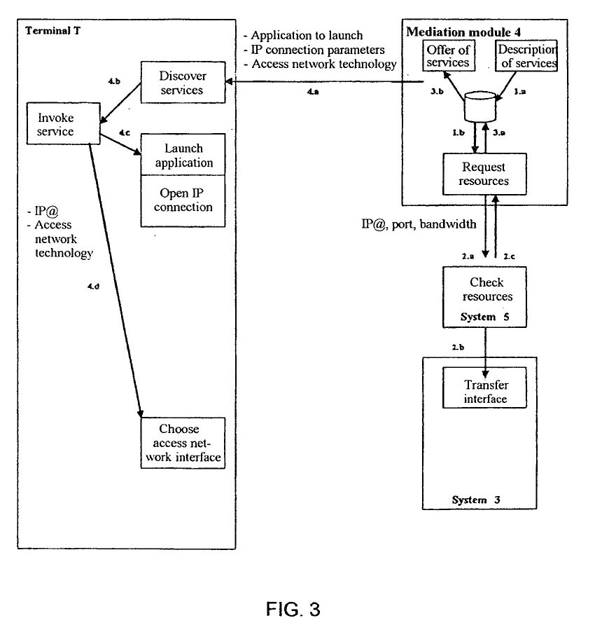

FIG. 2 is a diagram representing steps of the access method of the invention when the terminal accesses the IP service via a DAB access network.

FIG. 3 is a diagram representing steps of the access method of the invention when the terminal accesses the IP service via a plurality of interfaces.

The FIG. 1 communication system is intended to be used by a terminal T (such as a personal computer of a client) to access a service provided by a service provider and distributed by an IP content server S via a communication network 2, for example the Internet.

To access the required IP service, the terminal T uses a multipath access network 1 that in the remainder of the description is the DAB multichannel access network.

A system 3 connected to the network 1 hosts the transfer interfaces to the multichannel access network (for example IP data encapsulation gateways on DAB media) that switch the IP data stream to a channel defined by a logical channel/physical medium of the access network 1.

The system 3 may include signaling equipment specific to the access network 1. This optional signaling equipment gives final location characteristics of an IP service that in some cases only the access network 1 knows. In the example of a multicast IP service transported over a DAB access network, using the DAB access network signaling is obligatory: it is this signaling that supplies the link between a (SId, SCIds) pair and the channel in the DAB multiplexes.

The system 4 is a mediation module that hosts the signaling functions invoked by the IP service provider S. The mediation module 4 may belong to the service provider itself or to a third party used by the service provider.

The system 5 hosts control functions in respect of resources specific to the multichannel access network 1.

The network 1b is optional. The terminal T uses it to dialogue with the mediation module 4 via an access network other than the multichannel access network 1. This situation arises, for example, if the terminal T wishes to send messages to the system 4 when the multichannel access network 1 only transmits messages from the interface 3 to the terminal T. This situation arises in the DAB network, as it is unidirectional in the sender to receiver direction.

Data and information are exchanged in the FIG. 1 communication system in the following manner.

The IP content server S sends data to the terminal T via the network 2, the interface 3, and the multichannel access network 1.

The mediation module 4 dialogues with the system 5 via the network 2.

The system 5 dialogues with the interface 3 via the network 2.

The mediation module 4 dialogues with the terminal T via the network 2 and the network 1 or the network 1b.

The steps of the access method of the invention are described in detail and in relation to multichannel access next with reference to FIG. 2.

1.a—The IP service provider seeking to distribute its IP service to client terminals such as the terminal T uses the mediation module 4, which may be an integral part of the service provider server or subcontracted to a third party. To this end, the provider S supplies the description elements of its IP service to the “Service description” function of the module 4.

The elements supplied are those found in a standard SDP description file (see IETF RFC 327), namely:

application level information: the name and literal description of the service, the date of broadcasting of the service, the application needed to decode the service, the type of codecs, etc.,

network level data: the multicast IP address and the UDP port necessary to communicate with the multicast IP service.

If the service description information is insufficient to make the resource request explicit enough, complementary information is added to complete the resource request call effected during the step 1.b, if necessary. For example, in the case of a multicast IP service over DAB, the complementary information is the fact that the service provider wishes to broadcast the service using the DAB technology, the label of the radio service to which the IP service is attached, the necessary bandwidth, the geographical area in which the service will be provided, the required access network operator, etc.

The “Service description” function of the mediation module 4 stores the description of the service in the database of the module.

1.b—The “Resource request” function of the mediation module 4 is informed of the existence of a new IP service for which a resource request is necessary and must then select the operator of the access network 1.

It must then select the information that will characterize the resource request to the operator of the access network 1, for example the port and IP addresses of the IP stream, and a number of complementary elements such as the required bandwidth.

2.a—The “Resource activation” function of the system 5 receives the resource request.

2.b—If the request is admissible, for example if the necessary bandwidth is available in the DAB access resources, the system 5 sends instructions to the transfer equipments 3 in order for it to be possible for the IP service to be transported over the access network 1 on a given channel (given physical medium and given logical channel). The information transmitted to the equipments 3 characterizes the IP service (for example port, IP address) and designates the logical channel/physical medium to carry the IP service.

2.c—In response to the resource request of step 2.a, the “Resource control” function of the system 5 supplies the identifier for determining the channel to be used to transport the IP service over the multichannel access network 1. This field is referred to below as the “Access network channel location identifier”. In DAB, this identifier represents the (SId, SCIds) pair.

3.a—The “Resource request” function of the mediation module 4 updates the database of the module, associating the “Access network channel location identifier” field with the IP service description information.

3.b—The “Service offer” function of module 4 is informed that it must create a service discovery file associated with the IP service. If service discovery is effected by means of an SDP file, the file contains the fields present in the database and received by the service discovery function (these are fields of a standard SDP file) and the new “Access network channel location identifier” field. This field is placed in a media level SDP description if more than one medium and therefore more than one IP stream are associated with the IP service.

4.a—The “Service discovery” function of the client terminal T discovers the IP service:

either by sending a request to the “Service offer” function of the module 4, for example by downloading the SDP file to a worldwide web server updated by the “Service offer” function of the module 4,

or by the “Service offer” function sending information to the terminal T using a protocol such as SAP/SDP (see RFC 2974).

4.b—The “Service invocation” function, which may be invoked when the user selects the IP service on the graphical user interface of the terminal T (for example by clicking on an icon), processes the service discovery file (the SDP file, for example) and thus the “Access network channel location identifier” field.

4.c—The “Service invocation” function of the terminal T launches the application, supplying it with the parameters from the service discovery file that it needs. The application opens the IP connection using the IP communication parameters (conventionally the port and IP address(es)).

4.d—The “Service invocation” function communicates via an API type interface with the card of the terminal providing the connection to the access network 1 and supplies it with the parameters present in the “Access network channel location identifier” field.

Analyzing the signaling is optional on the access network 1 connection card, although it is obligatory in the case of a DAB network.

When the card of the terminal T is tuned to the correct channel (logical channel/physical medium), IP data coming from the service server S via the physical access network 1 is received by the receiver card of the terminal T and processed by the required application (for example a video player).

The steps of the access method of the invention in relation to multiple interface access are described in detail next with reference to FIG. 3.

The example of broadcasting a multicast IP service over a DAB access network is described here, the terminal being potentially able to receive multicast services over a plurality of network interfaces corresponding to different technologies.

1.a—An IP service provider seeking to distribute its IP service to client terminals like the terminal T it invokes the mediation module 4, which may be subcontracted to a third party or integrated into the service provider. To this end, the server S supplies the elements describing its IP service to the “Service description” function of the module 4.

The elements supplied are those found in a standard SDP description file (see IETF RFC 327), namely:

application level information: the name and literal description of the service, the date of broadcasting of the service, the application needed to decode the service, the type of codecs, etc.,

network level data: the multicast IP address and the UDP port necessary to communicate with the multicast IP service.

In addition to the service description information, and if necessary, the service provider supplies its preferences in terms of access network technology (for example: DAB if possible, DVB otherwise) and other complementary information in order to complete the resource request effected in step 1.b, if necessary, for example, in the case of a multicast IP service required to use a DAB technology: the label of the radio service to which the IP service is attached, the bandwidth necessary, the geographical area in which the service will be provided, the required access network operator, etc.

The “Service description” function of the system 4 stores the description of the service in the database of the system.

1.b—The “Resource request” function of the mediation module 4 is informed of the existence of a new IP service for which a resource request is necessary. The “Resource request” function must then select the access network technology and even the access network operator. The definitive choice of access network technology may be made as a function of the choices of the service provider, rules such as agreements with access operators, access network load information, and cost factors.

It must be noted that the same IP service can be transported simultaneously over several access networks using different technologies, for example DAB and DVB signaling. In this case, having the mediation module 4 establish an order of priority of the various technologies may be envisaged, that priority being imposed on the terminal T. Another solution is for the priority to be defined by the terminal T itself.

The “Resource request” function must then select the information that will characterize the resource request to the access network 1 operator, for example the port and IP addresses of the IP stream, together with a certain number of complementary elements such as the required bandwidth.

2.a—The “Resource activation” function of the system 5 receives the resource request.

2.b—If the request is admissible, for example if the necessary bandwidth is available in the DAB access resources, the system 5 sends instructions to the transfer equipments 3 in order for it to be possible to transport the IP service over the access network.

2.c—In response to the resource request effected in step 2.a, the “Resource control” function confirms the allocation of the resources.

3.a—The “Resource request” function of the system 4 updates the database of the system by adding to the description of the IP service the “Access network technology” field that defines the technology of the access network(s) used, accompanied by the associated priority if there is more than one possible access network, as indicated in step 1.b. In the case of a DAB access network, the value in this field will be equal to “DAB”, for example.

3.b—The “Service offer” function of the module 4 is informed that it must create a service discovery file associated with the IP service. If service discovery is effected by means of an SDP file, that file contains the fields present in the database and received by the service discovery function (these are fields of a standard SDP file) and the new “Access network technology” field. That field is placed in a media level SDP description if more than one medium and therefore more than one IP stream are associated with the IP service.

4.a—The client terminal T uses its “Service discovery” function to discover the IP service:

either by sending a request to the “Service offer” function of the module 4, for example by downloading the SDP file to a worldwide web server updated by the “Service offer” function of the module 4,

or by sending information to the terminal T by way of the “Service offer” function and using a protocol such as SAP/SDP (see RFC 2974).

4.b—The “Service invocation” function, which may be invoked when the user selects the IP service on the graphical user interface of the terminal T (for example by clicking on an icon), processes the service discovery file (an SDP file, for example) and thus the “Access network technology” field.

4.c—The “Service invocation” function of the terminal T launches the application, supplying it with the parameters from the service discovery file that it needs. The application opens the IP connection using the IP communication parameters (conventionally the port and IP address(es)).

4.d—The “Service invocation” function informs the “Choose access network interface” function that the IP service with the address @ must be obtained via an interface of the terminal T corresponding to the “Access network technology” field. In the case of a multicast IP service, for example, the “Choose access network interface” function modifies the network configuration parameters of the terminal so that the multicast subscription applies to the appropriate interface corresponding to the priorities defined by the mediation module 4 or locally by the terminal T. Note that in the case of multicast IP services another option is for the “Launch application” function to identify the interface to which the application must subscribe to consume the IP service, as a function of the “Access network technology” field supplied by the “Service invocation” function.

When the access network interface has been selected one way or another, IP data coming from the server S via the physical access network 1 is received by the receiver card of the terminal T and processed by the required application (for example a video player).

Note that the “multichannel” and “multiple interface” situations may be cumulative; if the access network defined by the mediation module is a multichannel access network, the channel identifier is transmitted to the terminal during service discovery at the same time as the path identifier. The “Choose access network interface” function then relays the identifier of the channel to the correct interface of the multichannel access network.

1. A method used by a terminal (T) to access via a multipath access network (1) a service made available on a communication network (2) by a service provider, which access method comprises the steps of:
the service provider supplying a mediation module (4) with information relating at least to the address (@, P) of said service in the communication network (2),
the mediation module (4) determining at least one path identifier to be used by the terminal (T) to access said service and associating said identifier with said information supplied by the service provider (S),
the terminal (T) receiving said identifier associated with said information from the mediation module (4) during service discovery.

2. The method according to claim 1, wherein the multipath access network is a multichannel access network and said identifier comprises a location identifier of the channel of said multichannel access network to be used by the terminal.

3. The method according to claim 2, wherein the mediation module (4) determines the multichannel access network (1) to be used and receives said location identifier from said access network.

4. The method according to claim 2, wherein said multichannel access network uses DVB signaling.

5. The method according to claim 2, wherein said path identifier further comprises an identifier of the technology of said multichannel access network.

6. The method according to claim 5, wherein said multichannel access network uses DAB signaling.

7. The method according to claim 6, wherein said path identifier consists of the couple (SId, SCIds).

8. The method according to claim 2, wherein said terminal (T) is tuned to the channel corresponding to said path identifier.

9. The method according to claim 1, wherein the multipath access network consists of a plurality of access network interfaces of the terminal and said path identifier is an identifier of at least one technology to be used.

10. The method according to claim 9, wherein the mediation module (4) determines the access technology to be used.

11. The method according to claim 10, wherein, if a plurality of technologies can be used, the mediation module (4) defines a relative priority of said technologies.

12. The method according to claim 10, wherein, if a plurality of technologies can be used, the terminal (T) defines a relative priority of said technologies.

13. The method according to claim 10, wherein, if there is a plurality of interfaces for a given technology, the terminal (T) determines the interface to be used.

14. The method according to claim 9, wherein said terminal (T) is connected to the network interface corresponding to said path identifier.

15. The method according to claim 1, wherein the information received by the mediation module (4) from the service provider also relates to the service.

16. A system used by a terminal (T) to access via a multipath access network (1) a service made available on a communication network (2) by a service provider,
wherein said access system comprises a mediation module (4) adapted:
to receive from the service provider information relating at least to the address (@, P) of said service in the communication network (2),
to determine at least one path identifier to be used by the terminal (T) to access said service and to associate said path identifier with said information supplied by the service provider (S), and
to supply the terminal (T) with said path identifier associated with said information during service discovery.

17. The access system according to claim 16, wherein the access network is a multichannel access network and the mediation module (4) is adapted to determine the multichannel access network (1) to be used and receives from said access network a location identifier of the channel to be used by the terminal (T).

18. The access system according to claim 16, wherein the multipath access network consists of a plurality of interfaces used by the terminal to access networks and the mediation module (4) is adapted to determine the access technology to be used.

19. The access system according to claim 16, wherein said terminal (T) is adapted to be tuned to the channel corresponding to said path identifier.

20. The access system according to claim 16, wherein said terminal (T) is adapted to be connected to the network interface corresponding to said path identifier.

21. A mediation module for a system used by a terminal (T) to access via a multipath access network (1) a service made available on a communication network (2) by a service provider, wherein said mediation module (4) is adapted:
to receive from the service provider information relating at least to the address (@, P) of said service in the communication network (2),
to determine at least one path identifier to be used by the terminal (T) to access said service and to associate said path identifier with said information supplied by the service provider (S), and
to supply the terminal (T) with said channel identifier associated with said information during service discovery.

22. The mediation module according to claim 21, wherein the access network is a multichannel access network and the mediation module (4) is adapted to determine the multichannel access network (1) to be used and receives from said access terminal a location identifier of the channel to be used by the terminal (T).

23. The mediation module according to claim 21, wherein the multipath access network consists of a plurality of interfaces used by the terminal to access networks and the mediation module (4) is adapted to determine the access technology to be used.
